(19) United States
(12) Patent Application Publication
(10) Pub. No.: US 2008/0172388 A1
(43) Pub. Date: Jul. 17, 2008

(54) Method and Related Multimedia System of Processing Files Stored in a Multimedia Server

(76) Inventors: Yung-Chih Lin, Taipei Hsien (TW); Shan-Yi Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/752,298

(22) Filed: May 23, 2007

(30) Foreign Application Priority Data
Jan. 16, 2007 (TW) 096101645

(51) Int. Cl. G06F 17/30

(52) U.S. Cl. 707/7; 707/E17.001

(57) ABSTRACT

A method of processing files stored in a multimedia server is disclosed. The method includes: a PC console acquiring the file information of the files stored in the multimedia server; the PC console analyzing the file information in the multimedia server and sorting the files stored in the multimedia server to generate a plurality of first nodes by a first sorting criterion; sorting the first nodes to generate a plurality of second nodes by a second sorting criterion; assigning a serial number for the first nodes and the second nodes respectively; the PC console generating a file information table in the multimedia server according to the first nodes and the second nodes; and searching the files stored in the multimedia server according to the file information table.

### BACKGROUND OF THE INVENTION

1. Field of the Invention

The present invention relates to a method and related multimedia systemof processing files stored in a multimedia server, and more particularly, to a method and related multimedia system utilizing a file information table to perform data processing.

2. Description of the Prior Art

Embedded devices always adopt a microprocessor or a single chip to realize a unitary function. The embedded devices adopt an independent operational system, so not a large number of facilities are needed and only a fixed size of memory (or flash memory), low efficiency microprocessors, and some simple hardware equipments are required. Hence, the embedded devices have advantages in volume, cost, and power consumption. For this reason, regardless of life equipments such as mobile phones, game players, and audio-video apparatus, or transportation system and auto-control of factory manufacture, the applications of the embedded devices are often seen.

Before the 21st century, the applications of the network and the multimedia were already intimate parts of our lives. Digital multimedia servers (DMS) are like a home computer used for storing and providing all kinds of multimedia files, such as audio files, video files, and image files. Digital multimedia players, such as high definition televisions or digital versatile disc players can connect to the digital multimedia servers and play the multimedia files stored in the digital multimedia servers through the network. A common digital multimedia server mostly utilizes databases to deal with data storage and data search, or processes the physical files directly. Due to calculation ability and memory space of the embedded devices being restricted, the time of the digital multimedia servers dealing with data storage and data search is extended.

### SUMMARY OF THE INVENTION

The claimed invention provides a method of processing files stored in a multimedia server. The method includes: a PC console acquiring the file information of the files stored in the multimedia server; the PC console analyzing the file information in the multimedia server and sorting the files stored in the multimedia server to generate a plurality of first nodes by a first sorting criterion; sorting the first nodes to generate a plurality of second nodes by a second sorting criterion; assigning a serial number for the first nodes and the second nodes respectively; the PC console generating a file information table in the multimedia server according to the first nodes and the second nodes; and searching the files stored in the multimedia server according to the file information table. The step of searching the files stored in the multimedia server according to the file information table includes processing a data search on a designated node, inputting the serial number of the designated node, searching the designated node in the file information table according to the serial number of the designated node, and acquiring the data of the designated node.

The claimed invention provides a method of processing files stored in a multimedia server. The method includes: analyzing the file information of the files stored multimedia server and sorting the files stored in the multimedia server to generate a plurality of first nodes by a first sorting criterion; sorting the first nodes to generate a plurality of second nodes by a second sorting criterion; assigning a serial number for the first nodes and the second nodes respectively; generating a file information table in the multimedia server according to the first nodes and the second nodes; and searching the files stored in the multimedia server according to the file information table. The step of searching the files stored in the multimedia server according to the file information table includes processing a data search on a designated node, inputting the serial number of the designated node, searching the designated node in the file information table according to the serial number of the designated node, and acquiring the data of the designated node. The step of searching the files stored in the multimedia server according to the file information table includes processing a data search on a child node of a designated node, inputting the serial number of the designated node, searching the designated node in the file information table according to the serial number of the designated node, acquiring the serial number of a first child node of the designated node, searching the first child node of the designated node in the file information table according to the serial number of the first child of the designated node, and acquiring the data of the child node of the designated node.

The claimed invention provides a multimedia system utilizing file information tables to process data. The multimedia system includes a multimedia server and a PC console. The multimedia server includes a storage unit, a file information table, and a file information table access unit. The storage unit is used for storing multimedia files. The file information table is used for storing a file information corresponding to the multimedia files stored in the storage unit. The file information table access unit is used for searching the multimedia files stored in the storage unit according to the file information table. The PC console includes a file access and analysis unit and a file information table generating unit. The file access and analysis unit is used for acquiring and analyzing the multimedia files stored in the storage unit to generate an analysis result. The file information table generating unit is used for generating the file information table according to the analysis result. The file access and analysis unit is used for analyzing the file information in the multimedia server and sorting the files stored in the multimedia server to generate a plurality of first nodes by a first sorting criterion; sorting the first nodes to generate a plurality of second nodes by a second sorting criterion; and assigning a serial number for the first nodes and the second nodes respectively. The file information table access unit is used for inputting a serial number of the designated node, searching the designated node in the file information table according to the serial number of the designated node, and acquiring the data of the designated node.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a structure of a multimedia system according to an embodiment of the present invention.

FIG. 2 is a diagram showing the internal elements of the first digital multimedia server and the PC console in FIG. 1.

FIG. 3 is a diagram illustrating a flow of a method of processing files stored in a multimedia server according to an embodiment of the present invention.

FIG. 4 is a diagram illustrating an operational flow of the PC console in FIG. 1.

FIG. 5 is a diagram illustrating another operational flow of the PC console in FIG. 1.

FIG. 6 is a diagram illustrating an operational flow of the first digital multimedia server in FIG. 2.

FIG. 7 is a diagram illustrating a tree structure of a file information table according to an embodiment of the present invention.

FIG. 8 is another diagram illustrating the tree structure of the file information table in FIG. 7.

FIG. 9 is a diagram illustrating a flow of a search manner in the file information table.

FIG. 10 is a diagram illustrating a flow of another search manner in the file information table.

### DETAILED DESCRIPTION

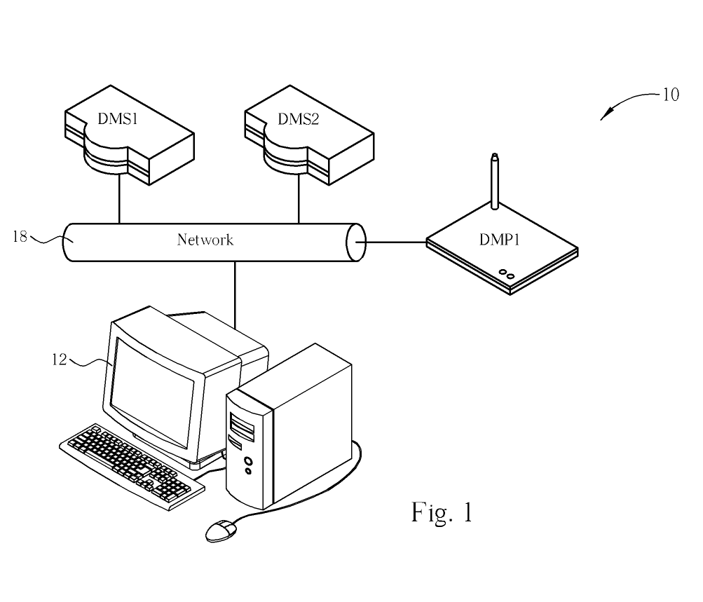

Please refer to FIG. 1. FIG. 1 is a diagram illustrating a structure of a multimedia system 10 according to an embodiment of the present invention. The multimedia system 10 includes a first digital multimedia server DMS1, a second digital multimedia server DMS2, a PC console 12, and a digital multimedia player DMP1. In this embodiment, the first digital multimedia server DMS1 and the second digital multimedia server DMS2 are embedded systems, which are used for storing and providing all kinds of multimedia files, such as audio data, video data, and image data. The PC console 12 is a control interface of the first digital multimedia server DMS1 and the second digital multimedia server DMS2, which can perform related settings and process files stored in the first digital multimedia server DMS1 and the second digital multimedia server DMS2 through a network 18. The digital multimedia player DMP1 can be a high definition television (HDTV) or a digital versatile disc player (DVD player), which can connect to the first digital multimedia server DMS1 or the second digital multimedia server DMS2 for playing the multimedia files stored in the first digital multimedia server DMS1 or the second digital multimedia server DMS2 through the network 18.

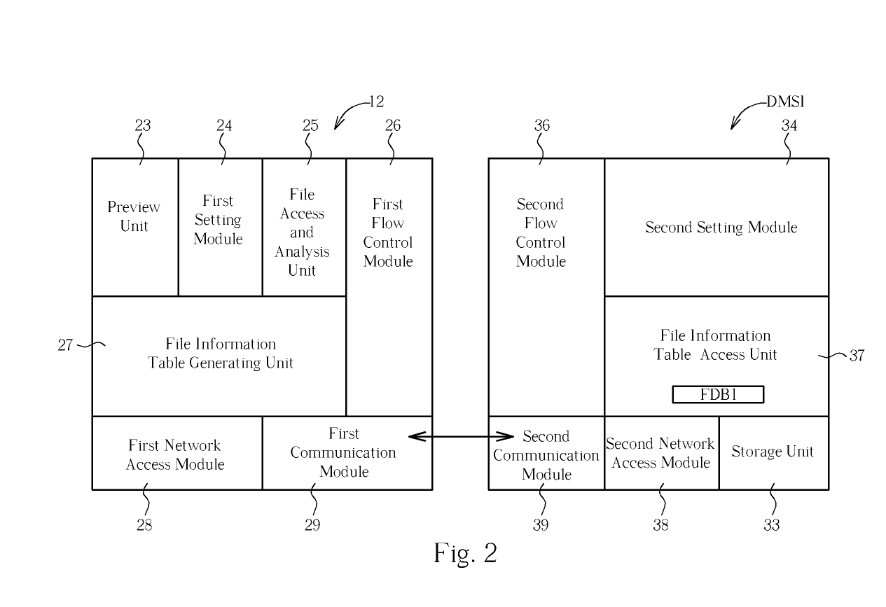

Please refer to FIG. 2. FIG. 2 is a diagram showing the internal elements of the first digital multimedia server DMS1 and the PC console 12 in FIG. 1. The PC console 12 includes a preview unit 23, a first setting module 24, a file access and analysis unit 25, a file information table generating unit 27, a first network access module 28, a first communication module 29, and a first flow control module 26. The first digital multimedia server DMS1 includes a second setting module 34, a storage unit 33, a file information table FDB1 , a file information table access unit 37, a second network access module 38, a second communication module 39, and a second flow control module 36. The storage unit 33 is used for storing the multimedia files, and the file access and analysis unit 25 acquires and analyzes the multimedia files stored in the storage unit 33 to generate an analysis result. Afterwards the file information table generating unit 27 generates the file information table FDB1 in the first digital multimedia server DMS1 according to the analysis result generated by the file access and analysis unit 25. The file information table FDB1 is used for storing file information corresponding to the multimedia files stored in the storage unit 33. Finally, the file information table access unit 37 searches the multimedia files stored in the storage unit 33 according to the file information table FDB1.

Please keep referring to FIG. 2. The preview unit 23 is used for previewing the data in the first digital multimedia server DMS1. The first setting module 24 is used for transmitting a setting command to perform settings on the first digital multimedia server DMS1, such as DMS name, IP setting, etc. The second setting module 34 is used for receiving the setting command transmitted from the first setting module 24 to perform the settings on the first digital multimedia server DMS1. The first network access module 28 and the second network access module 38 are used for transmitting and receiving a DLNA command or an UPnP command. The second communication module 39 is used for communicating with the first communication module 29.

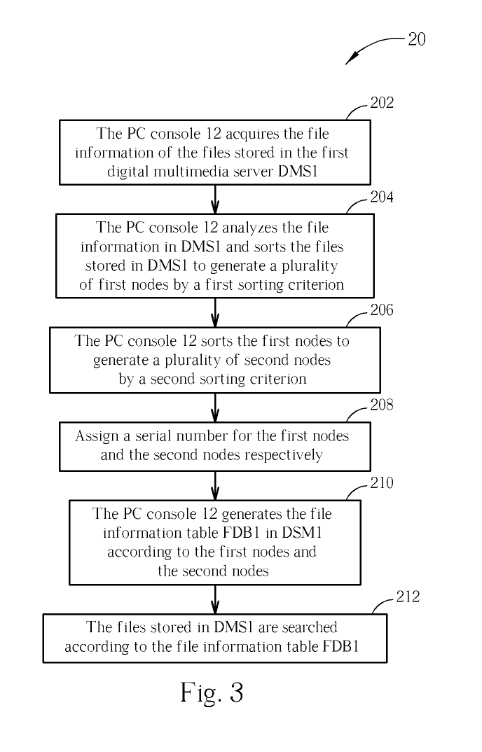

Please refer to FIG. 2 and FIG. 3. FIG. 3 is a diagram illustrating a flow 20 of a method applied to data processing in a multimedia server according to an embodiment of the present invention. The flow 20 includes the following steps:

Step 202: The PC console 12 acquires the file information of the files stored in the first digital multimedia server DMS1.

Step 204: The PC console 12 analyzes the file information in first digital multimedia server DMS1 and sorts the files stored in the first digital multimedia server DMS1 to generate a plurality of first nodes according to a first sorting criterion.

Step 206: The PC console 12 sorts the first nodes to generate a plurality of second nodes according to a second sorting criterion.

Step 208: Assign a serial number for the first nodes and the of second nodes respectively.

Step 210: The PC console 12 generates the file information table FDB1 in the first digital multimedia server DSM1 according to the first nodes and the second nodes.

Step 212: The files stored in the first digital multimedia server DMS1 are searched according to the file information table FDB1.

The PC console 12 acquires the multimedia files stored in the storage unit 33 through the file access and analysis unit 25 (step 202). Afterward the PC console 12 sorts the files to generate the first nodes and the second nodes by the first sorting criterion and the second sorting criterion, and assign the serial number for each first node and each second node respectively (steps 204-208). The PC console 12 utilizes the file information table generating unit 27 to generate the file information table FDB1 in the first digital multimedia server DMS1 (step 210). The file information table FDB1 is used for storing the file information corresponding to the multimedia files stored in the storage unit 33. Finally, the file information table access unit 37 can search the files stored in the first digital multimedia server DMS1 according to the file information table FDB1 (step 212).

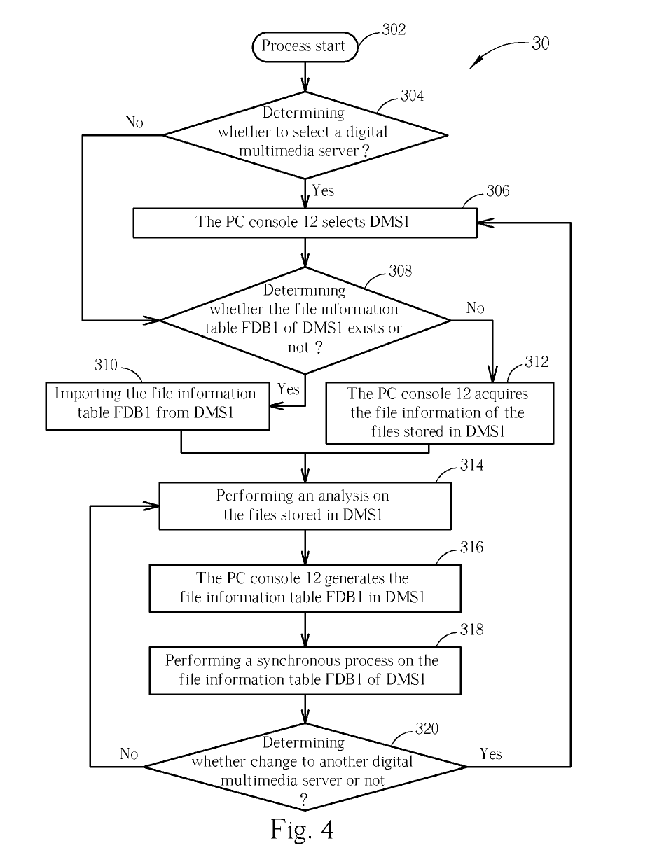

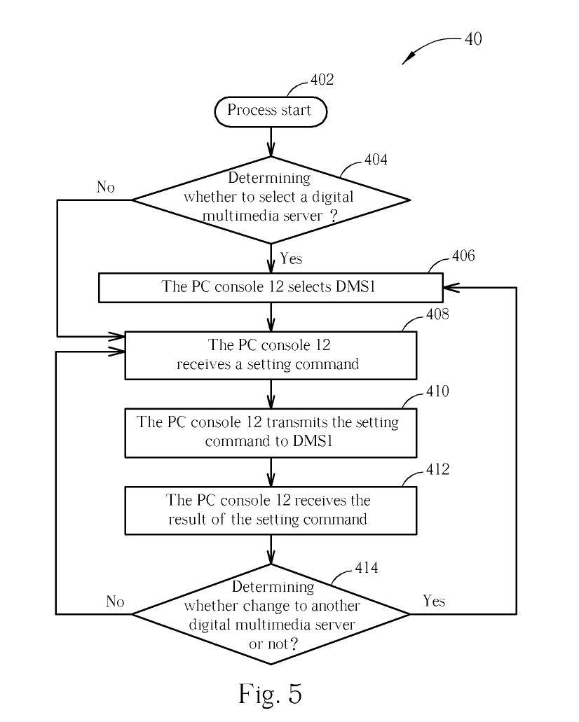

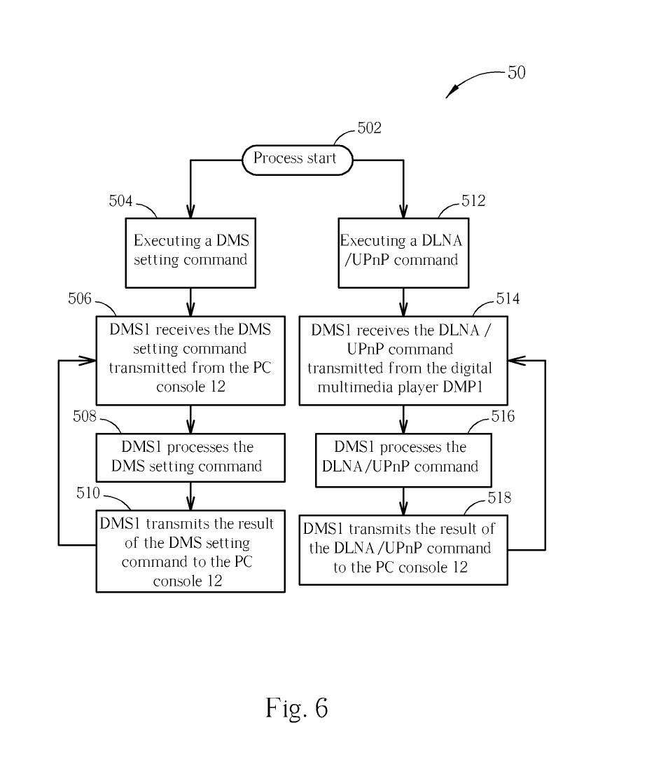

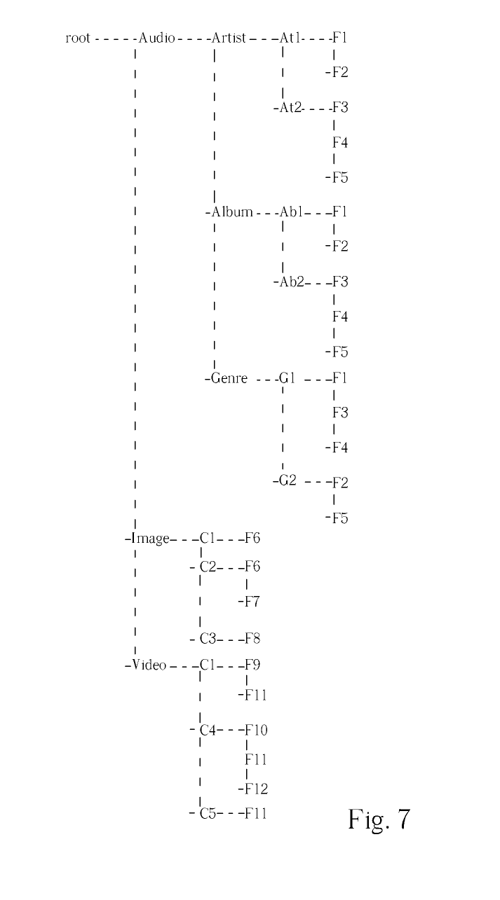

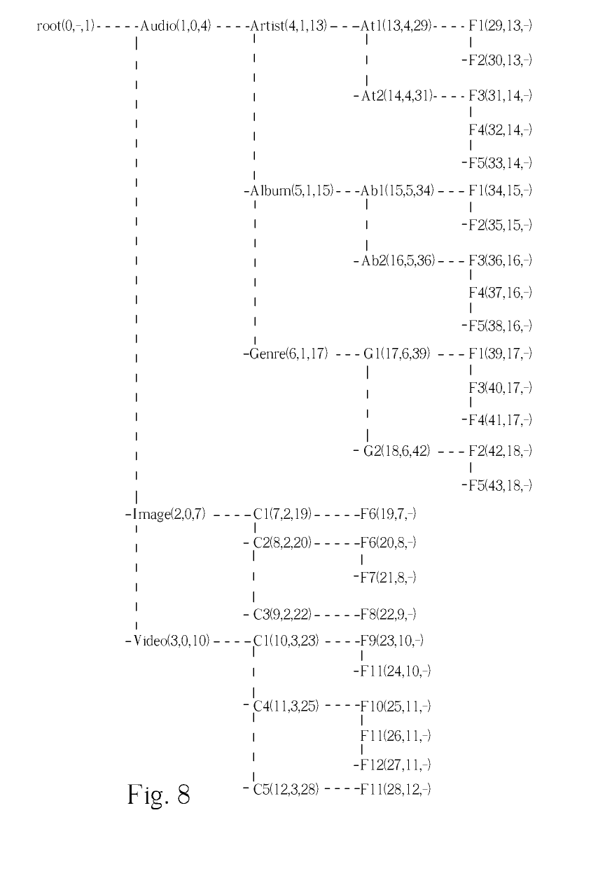

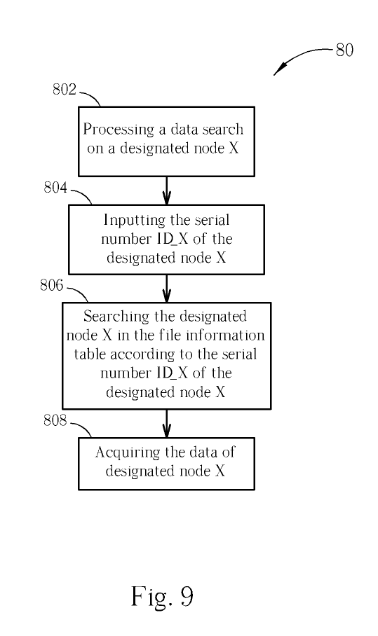

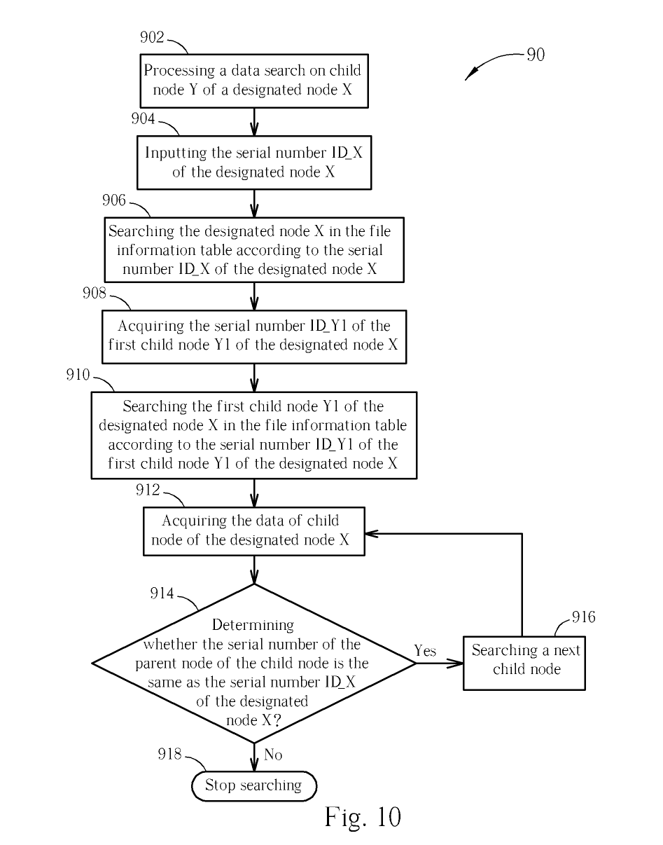

Descriptions about how the PC console acquires and analyzes the files stored in the multimedia server will be explained in detail in FIG. 4. The tree structures and physical storage manners of the file information table will be explained in the embodiments in FIG. 7 and FIG. 8. The search manners of the file information table will be illustrated in FIG. 9 and FIG. 10. Furthermore, about how the PC console 12 transmits the setting command to perform the settings on the first digital multimedia server DMS1 will be described in FIG. 5. How the first digital multimedia server DMS1 receives the setting command transmitted from the first setting module 24 and how to perform settings on the first digital multimedia server DMS1 will be described in FIG. 6.

Please refer to FIG. 4, FIG. 1, and FIG. 2. FIG. 4 is a diagram illustrating an operational flow 30 of the PC console 12 in FIG. 1. The operational flow 30 includes the following steps:

Step 302: Process start.

Step 304: Determine whether to select a digital multimedia server.

Step 306: The PC console 12 selects the first digital multimedia server DMS1.

Step 308: Determine whether the file information table FDB1 of the first digital multimedia server DMS1 exists or not.

Step 310: Import the file information table FDB1 from the first digital multimedia server DMS1.

Step 312: The PC console 12 acquires the file information of the files stored in the first digital multimedia server DMS1.

Step 314: Perform an analysis on the files stored in the first digital multimedia server DMS1.

Step 316: The PC console 12 generates the file information table FDB1 in the first digital multimedia server DMS1.

Step 318: Perform a synchronous process on the file information table FDB1 of the first digital multimedia server DMS1.

Step 320: Determine whether change to another digital multimedia server or not.

The PC console 12 is capable of connecting to several digital multimedia servers through the network 18. Hence, in the step 306, the PC console 12 selects the first digital multimedia server DMS1 first. In the step 308, the file information table FDB1 is determined to exist first, the file information table FDB1 is imported from the first digital multimedia server DMS1 directly if the file information table FDB1 already exists (step 310); and the PC console 12 will acquire the file information of the files stored in the first digital multimedia server DMS1 if the file information table FDB1 does not exist (step 312). After performing the analysis on the files stored in the first digital multimedia server DMS1, the PC console 12 generates (or modifies) the file information table FDB1 in the first digital multimedia server DMS1, whereof the file information table FDB1 is used for storing the file information corresponding to the multimedia files stored in the first digital multimedia server DMS1. Finally, the process goes back to step 306 if the users want to change to another digital multimedia server; otherwise, the process returns to step 314.

Please refer to FIG. 5 and FIG. 1. FIG. 5 is a diagram illustrating another operational flow 40 of the PC console 12 in FIG. 1. The operational flow 40 includes the following steps:

Step 402: Process start.

Step 404: Determine whether to select a digital multimedia server.

Step 406: The PC console 12 selects the first digital multimedia server DMS1.

Step 408: The PC console 12 receives a setting command.

Step 410: The PC console 12 transmits the setting command to the first digital multimedia server DMS1.

Step 412: The PC console 12 receives the result of the setting command.

Step 414: Determine whether change to another digital multimedia server or not.

The operational flow 30 in FIG. 4 and the operational flow 40 in FIG. 5 are used for illustrating the communication between the PC console 12 and the first digital multimedia server DMS1 (command transmission manner), whereof the operational flow 30 illustrates the operational condition at the PC console side and the operational flow 40 illustrates the operational condition at the first digital multimedia server DMS1. The setting command can be a DMS setting command or a DLNA/UPnP command, whereof the DMS setting command is a related command used for performing settings on the first digital multimedia server DMS1 and the DLNA/UPnP command is a standard protocol used as a mutual communication or control between devices of a local network (or a home network).

Please refer to FIG. 6, FIG. 1, and FIG. 5. FIG. 6 is a diagram illustrating an operational flow 50 of the first digital multimedia server DMS1 in FIG. 2. The operational flow 50 includes the following steps:

Step 502: Process start.

Step 504: Execute a DMS setting command.

Step 506: The first digital multimedia server DMS1 receives the DMS setting command transmitted from the PC console 12.

Step 508: The first digital multimedia server DMS1 processes the DMS setting command.

Step 510: The first digital multimedia server DMS1 transmits the result of the DMS setting command to the PC console 12.

Step 512: Execute a DLNA/UPnP command.

Step 514: The first digital multimedia server DMS1 receives the DLNA/UPnP command transmitted from the digital multimedia player DMP1.

Step 516: The first digital multimedia server DMS1 processes the DLNA/UPnP command.

Step 518:The first digital multimedia server DMS1 transmits the result of the DLNA/UPnP command to the PC console 12.

The operational flow 50 is divided into two portions, whereof steps 504-510 are used for illustrating the operational condition of the first digital multimedia server DMS1 receiving the DMS setting command transmitted from the PC console 12, and steps 512-518 are used for illustrating the operational condition of the first digital multimedia server DMS1 receiving the DLNA/UPnP command transmitted from the digital multimedia player DMP1.

Please refer to FIG. 7. FIG. 7 is a diagram illustrating a tree structure of a file information table according to an embodiment of the present invention. After analyzing the multimedia files stored in the digital multimedia server through the PC console, the multimedia files will be expanded to a tree structure. General multimedia files can be divided into Audio, Video and Image, whereof the Audio can be divided into Artist, Album, and Genre, and the Video and the Image can be sorted according to file catalogs. Assuming that the multimedia files stored in the digital multimedia servers include audio files F1, F2, F3, F4, and F5, image files F6, F7, and F8, and video files F9, F10, F11, and F12. For example, if the audio files F1, F2, F3, F4, and F5 are sorted according to artists, then the audio files F1 and F2 are grouped into a first artist At1, the audio files F3, F4, and F5 are grouped into a second artist At2. In this embodiment, sorting the multimedia files into the Audio, the Image, and the Video belongs to a first sorting criterion. Sorting the audio files into Artist, Album, and Genre, sorting the image files into the file catalogs C1, C2, and C3, and sorting the video files into the file catalogs C1, C4, and C5 all belong to a second sorting criterion. Sorting the Artist into the first artist At1 and the second artist At2 belongs to a third sorting criterion. As shown in FIG. 7, the tree structure of the multimedia files is obtained through the first sorting criterion, the second sorting criterion, and the third sorting criterion.

Please refer to FIG. 8 and FIG. 7. FIG. 8 is another diagram illustrating the tree structure of the file information table in FIG. 7. A node represents the related information of each multimedia file, and each node is numbered in order. The related information stored in each node includes the serial number of the node, the serial number of the parent node of the node, and the serial number of the first child node of the node. As shown in FIG. 8, a root is represented by (0,-,1), through which it can be known that the serial number of the root is 0 and the serial number of the first node is 1. The first artist At1 is represented by (13,4,29), through which it can be known that the serial number of the first artist At1 is 13, the serial number of its parent node is 4, and the serial number of the first child node is 29. The data size of each node is all the same.

Please refer to FIG. 9, which is a diagram illustrating a flow 80 of a search manner in the file information table. The flow 80 includes the following steps:

Step 802: Process a data search on a designated node X.

Step 804: Input the serial number ID_X of the designated node X.

Step 806: Search the designated node X in the file information table according to the serial number ID_X of the designated node X.

Step 808: Acquire the data of designated node X.

The flow 80 is used for processing the data search on the designated node X. Only if the serial number ID_X of the designated node X is inputted, the designated node X can be found in the file information table to obtain the data of the designated node X. Due to all data searches being able to obtain the data directly according to the serial number of the nodes and the data size of each node being the same, the search time is a constant time T.

Please refer to FIG. 10, which is a diagram illustrating a flow 90 of another search manner in the file information table. The flow 90 includes the following steps:

Step 902: Process a data search on child node Y of a designated node X.

Step 904: Input the serial number ID_X of the designated node X.

Step 906: Search the designated node X in the file information table according to the serial number ID_X of the designated node X.

Step 908: Acquire the serial number ID_Y1 of the first child node Y1 of the designated node X.

Step 910: Search the first child node Y1 of the designated node X in the file information table according to the serial number ID_Y1 of the first child node Y1 of the designated node X.

Step 912: Acquire the data of child node of the designated node X.

Step 914: Determine whether the serial number of the parent node of the child node is the same as the serial number ID_X of the designated node X.

Step 916: Search a next child node.

Step 918: Stop searching.

The flow 90 is used for processing the data search on the child node Y of the designated node X. Only if the serial number ID_X of the designated node X is inputted, the designated node X can be found in the file information table to further find the serial number ID_Y1 of the first child node of the designated node X (steps 902-908). Finally, the first child node Y1 of the designated node X is found in the file information table to obtain the data of the child nodes of the designated node X according to the serial number ID_Y1 of the first child node of the designated node X (steps 910-912). Furthermore, through judging whether the serial number of the parent node of each child node is the same as the serial number ID_X of the designated node X, the information of all child nodes of the designated node X can be found. Due to all data searches of the child nodes being able to obtain the data directly according to the serial number of the nodes and the data size of each node being the same, the search time is a constant time T.

The above mentioned embodiments are presented merely for describing the present invention, and in no way should be considered to be limitations of the scope of the present invention. The first sorting criterion, the second sorting criterion, and the third sorting criterion are not restricted to these only, and other sorting criterions can be utilized. Furthermore, the related information stored in each node is not restricted to the serial number of the node, the serial number of the parent node of the node, and the serial number of the first child node of the node only, the storage place of the files or other related information can be stored.

From the above descriptions, the present invention provides a method and related multimedia system applied to data processing of a multimedia server. Due to the calculation ability and memory space of embedded devices being limited, the storage table, the usage space of the table, and physical data processing time can be saved if the mechanism of the present invention is used to replace the prior art data processing manner, which can improve efficiency of the whole system. Furthermore, each node is numbered in order, so fast search effect can be reached to directly acquire the related information of the node based on searching by index values. The related information stored in each node includes the serial number of the node, the serial number of the parent node of the node, and the serial number of the first child node of the node, whereof its child nodes or its parent node can be found out through the serial number of the node.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of processing files stored in a multimedia server, the method comprising:
a PC (personal computer) console acquiring the file information of the files stored in the multimedia server;
the PC console analyzing the file information in the multimedia server and sorting the files stored in the multimedia server to generate a plurality of first nodes by a first sorting criterion;
sorting the first nodes to generate a plurality of second nodes by a second criterion; assigning a serial number for the first nodes and the second nodes respectively;
the PC console generating a file information table in the multimedia server according to the first nodes and the second nodes; and
searching the files stored in the multimedia server according to the file information table.

2. The method of processing files stored in a multimedia server of claim 1 further comprising:
a multimedia server setting process comprising:
the PC console receiving a setting command;
the PC console transmitting the setting command to the multimedia server;
the multimedia server processing the setting command; and
the multimedia server transmitting results of the setting command to the PC console.

3. The method of processing files stored in a multimedia server of claim 2, wherein the setting command is a DLNA (digital living network alliance) command or an UPnP (universal plug and play) command.

4. The method of processing files stored in a multimedia server of claim 1, wherein the step of the PC console generating the file information table in the multimedia server according to the first nodes and the second nodes comprises:
storing a data of the first nodes and a data of the second nodes in the multimedia server to generate the file information table according to the serial numbers of the first nodes and the second nodes;
wherein a data size of each first node equals a data size of each second node.

5. The method of processing files stored in a multimedia server of claim 1, wherein the step of assigning the serial number for the first nodes and the second nodes respectively comprises:
numbering the first nodes from the serial numbers 0 to (N−1) in order; and
numbering the second nodes from the serial numbers N to (N+M−1) in order;
wherein N is an amount of the first nodes and M is an amount of the second nodes.

6. The method of processing files stored in a multimedia server of claim 1 further comprising:
sorting the second nodes to generate a plurality of third nodes by a third criterion;
wherein the first nodes, the second nodes, and the third nodes construct a tree structure.

7. The method of processing files stored in a multimedia server of claim 1, wherein the step of searching the files stored in the multimedia server according to the file information table comprises:
processing a data search on a designated node;
inputting the serial number of the designated node;
searching the designated node in the file information table according to the serial number of the designated node; and
acquiring the data of the designated node.

8. The method of processing files stored in a multimedia server of claim 1, wherein the step of searching the files stored in the multimedia server according to the file information table comprises:
processing a data search on a child node of a designated node;
inputting the serial number of the designated node;
searching the designated node in the file information table according to the serial number of the designated node;
acquiring the serial number of a first child node of the designated node;
searching the first child node of the designated node in the file information table according to the serial number of the first child of the designated node; and
acquiring the data of the child of the designated node.

9. The method of processing files stored in a multimedia server of claim 8 further comprising:
determining whether the serial number of a parent node of the child node is the same as the serial number of the designated node; and
searching a next child node when the serial number of the parent node of the child node is the same as the serial number of the designated node.

10. A method of processing files stored in a multimedia server of, the method comprising:
analyzing the file information of the files stored the multimedia server and sorting the files stored in the multimedia server to generate a plurality of first nodes by a first sorting criterion;
sorting the first nodes to generate a plurality of second nodes by a second sorting criterion;
assigning a serial number for the first nodes and the second nodes respectively;
generating a file information table in the multimedia server according to the first nodes and the second nodes; and
searching the files stored in the multimedia server according to the file information table;
wherein a data size of each first node equals a data size of each second node.

11. The method of processing files stored in a multimedia server of claim 10, wherein the step of assigning the serial number for the first nodes and the second nodes respectively comprises:
numbering the first nodes from the serial numbers 0 to (N−1) in order; and
numbering the second nodes from the serial numbers N to (N+M−1) in order;
wherein N is an amount of the first nodes and M is an amount of the second nodes.

12. The method of processing files stored in a multimedia server of claim 10 further comprising:
sorting the second nodes to generate a plurality of third nodes by a third sorting criterion;
wherein the first nodes, the second nodes, and the third nodes construct a tree structure.

13. The method of processing files stored in a multimedia server of claim 10, wherein the step of searching the files stored in the multimedia server according to the file information table comprises:
processing a data search on a designated node;
inputting the serial number of the designated node;
searching the designated node in the file information table according to the serial number of the designated node; and
acquiring the data of the designated node.

14. The method of processing files stored in a multimedia server of claim 10, wherein the step of searching the files stored in the multimedia server according to the file information table comprises:
processing a data search on a child node of a designated node;
inputting the serial number of the designated node;
searching the designated node in the file information table according to the serial number of the designated node;
acquiring the serial number of a first child node of the designated node;
searching the first child node of the designated node in the file information table according to the serial number of the first child of the designated node; and
acquiring the data of the child node of the designated node.

15. The method of processing files stored in a multimedia server of claim 14 further comprising:
determining whether the serial number of a parent node of the child node is the same as the serial number of the designated node; and
searching a next child node when the serial number of the parent node of the child node is the same as the serial number of the designated node.

16. A multimedia system utilizing file information table to process data, the multimedia system comprising:
a multimedia server comprising:
a storage unit used for storing multimedia files;
a file information table used for storing a file information corresponding to the multimedia files stored in the storage unit; and
a file information table access unit used for searching the multimedia files stored in the storage unit according to the file information table; and
a PC (personal computer) console comprising:
a file access and analysis unit used for acquiring and analyzing the multimedia files stored in the storage unit to generate an analysis result; and
a file information table generating unit used for generating the file information table according to the analysis result.

17. The multimedia system of claim 16, wherein the PC console further comprises:
a first setting module used for transmitting a setting command;
a first network access module used for transmitting and receiving a DLNA command or an UPnP command; and
a first communication module.

18. The multimedia system of claim 17, wherein the multimedia server further comprises:
a second setting module used for receiving the setting command transmitted by the first setting module to processing a setting on the multimedia server;
a second network access module used for transmitting and receiving the DLNA command or the UPnP command; and
a second communication module used for communicating with the first communication module.

19. The multimedia system of claim 16, wherein the file access and analysis unit is used for:
analyzing the multimedia server and sorting the files stored in the multimedia server to generate a plurality of first nodes by a first sorting criterion;
sorting the first nodes to generate a plurality of second nodes by a second sorting criterion; and
assigning a serial number for the first nodes and the second nodes respectively.

20. The multimedia system of claim 19, wherein the file access and analysis unit is further used for:
sorting the second nodes to generate a plurality of third nodes by a third sorting criterion.

21. The multimedia system of claim 16, wherein the file information table access unit is used for:
inputting a serial number of the designated node;
searching the designated node in the file information table according to the serial number of the designated node; and
acquiring the data of the designated node.

22. The multimedia system of claim 16, wherein the file information table access unit is used for:
inputting a serial number of the designated node;
searching the designated node in the file information table according to the serial number of the designated node;
acquiring the serial number of a first child node of the designated node;
searching the first child node of the designated node in the file information table according to the serial number of the first child of the designated node; and
acquiring the data of the child node of the designated node;
determining whether the serial number of a parent node of the child node is the same as the serial number of the designated node; and
searching a next child node when the serial number of the parent node of the child node is the same as the serial number of the designated node.
